(19) United States
(12) Patent Application Publication
(10) Pub. No.: US 2004/0181622 A1
(43) Pub. Date: Sep. 16, 2004

(54) USB Infrared receiver/Transmitter device

(76) Inventors: Chris Kiser, Albuquerque, NM (US); Jason Hoy, Albuquerque, NM (US)

Correspondence Address: CARSTENS YEE & CAHOON, LLP, P O BOX 802334, DALLAS, TX, 75380

(21) Appl. No.: 10/385,779

(22) Filed: Mar. 11, 2003

(51) Int. Cl. G06F 13/12

(52) U.S. Cl. 710/72

(57) ABSTRACT

A system for remotely controlling multiple appliances with a configurable interface for a user. A transceiver device preferably having an infra-red (IR) receiver and transmitters samples and stores IR remote control signals from a remote control device associated with an appliance. The transceiver device communicates with a computer having a user interface program. The user selects an interface and associates an input action with a sampled IR remote signal so that by performing the input action, the computer causes the transceiver device to transmit the sampled signal to the appliance. The system provides the user with a master remote control system capable of controlling multiple appliances from a variable, configurable software interface.

### BACKGROUND OF THE INVENTION

1. Technical Field

The present invention relates to electronic appliance remote control, and more particularly to control of multiple appliances through a single interface.

2. Description of Related Art

Many appliances in homes, particularly entertainment equipment such as televisions, stereos, and VCRs, use remote control devices. Typical remote controls are devices that emit infra-red (IR) signals that are received by the appliance to which the remote is designed to communicate. The signals from the remote control the operation of the appliance.

A “master” remote control is one that is capable of controlling multiple appliances. Typical master remotes are able to “learn” the signals of other remote controls, so that the master remote can reproduce the signals to control the appliance associated with the non-master remote. Master remotes typically learn other remote signals by sampling or recording the signals and storing them. A signal that is recorded is associated with a button on the master remote, and by depressing the button, the new learned signal can be emitted by the master remote to control the appliance. Master remotes therefore typically have a plethora of buttons, so that different kinds of appliances can be controlled. For example, there may be buttons on the master remote for controlling a VCR, such as a play button, fast forward, rewind, record, and scan. The master remote might also contain buttons (located on a different area of the remote) that are designed to control a stereo, for example, with buttons for pre-set stations, tuning, playing music media such as a compact disk, and selecting particular tracks on a CD, for example. Thus, the control of multiple appliances usually requires a plurality of buttons on the master remote to accommodate the many possible functions the master remote can learn, and to present these options to a user in an easy-to-understand format. Unfortunately, the addition of functionality on such a remote typically decreases ease of use because the master remote must be hard-wired to accept and learn that many more functions. Presenting more and more functions to a user requires more buttons, and space to provide new buttons is limited. The limits of most master remotes is reached when the remote itself is so packed with buttons that a person's fingers cannot select one without impinging on surrounding buttons.

It would therefore be advantageous to have a remote control that is capable of adding functionality without decreasing ease of use, and which is capable of controlling multiple appliances.

### SUMMARY OF THE INVENTION

The present invention provides a system to remotely control a plurality of appliances that are responsive to remote control signals such as IR signals. A preferred embodiment is described in summary here: A transceiver device has an IR receiver and IR transmitters connected to receive and sample IR signals from a remote control, the remote control being designed to communicate with an appliance via IR signals. The IR signals from the standard remote are sampled by the innovative system and stored, and a user of the system uses a software interface on a computer (to which the transceiver device communicates, preferably via a USB connection) to associate the sampled IR signal with an input action. The input actions of the software are configurable by the user, so that a user can use the innovative system to “learn” multiple remote control signals (for multiple appliances), associate each signal with a specific user input action, and later perform the user input action to cause the transceiver to emit the sampled signal associated with that particular action. Thus, the innovative system allows a user to create a master remote control capable of being configured by the user and capable of controlling multiple appliances from a computer terminal.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 shows a block diagram of a preferred embodiment of the present invention.

FIG. 2 shows a flow chart of a preferred embodiment of the present invention.

FIG. 3 shows a flow chart of a preferred embodiment of the present invention.

FIG. 4 show learn mode and transmit mode of the innovative system, respectively.

FIG. 5 shows an example of a user configurable interface.

### DETAILED DESCRIPTION OF THE INVENTION

The description of the present invention has been presented for purposes of illustration and description, and is not intended to be exhaustive or to limit the invention to the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

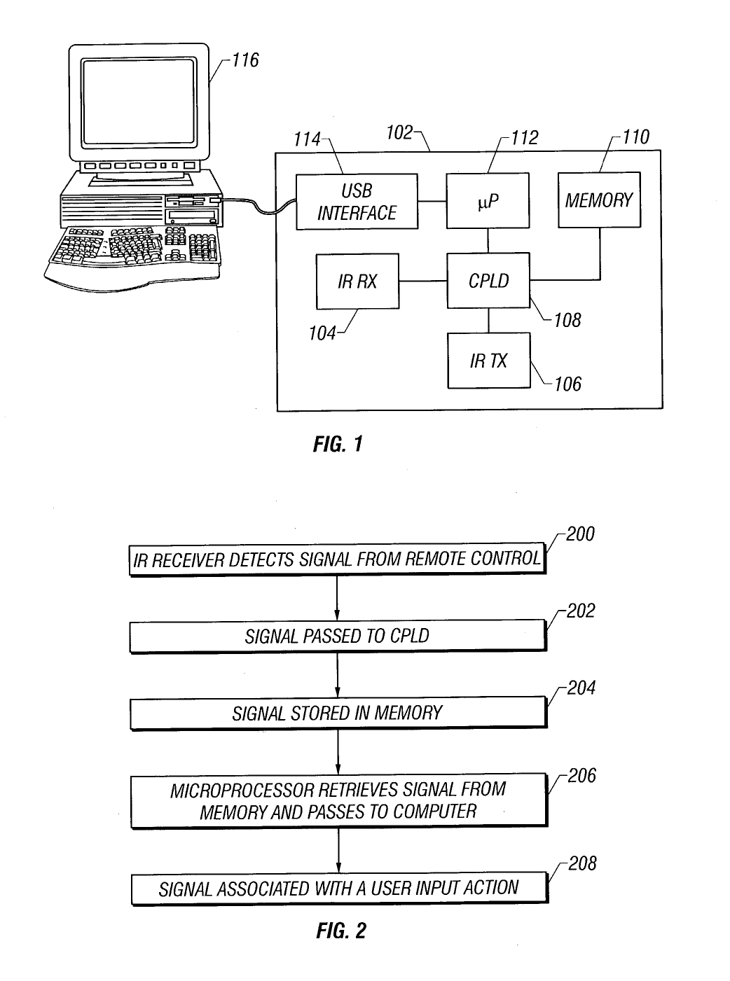

The current innovations are described with reference to the figures. FIG. 1 shows a preferred embodiment of the present innovations. This embodiment comprises a transceiver device 102 having a receiver 104 for receiving infra-red (IR) signals and a plurality (preferably five) transmitters 106 for transmitting IR signals. The transmitters 106 are preferably IR wavelength LEDs (light emitting diodes). The transmitters 106 and receiver 104 are preferably connected to a complex programmable logic device 108, or CPLD. This device includes a shift register used to store and output the signal pulse patterns of the remote controls. The CPLD is connected to an external memory device 110, preferably a random access memory device. The CPLD is also connected to a microprocessor 112. The microprocessor 112 has access to a USB interface 114. The USB interface is preferably connected with a USB port of a computing device 116, preferably a personal computer.

On the transceiver device itself, the IR transmitters are preferably positioned on all sides, so that the device can transmit omni-directionally. The USB is preferably self powered, meaning that no additional external power source is required for the transceiver device. Typical USB can power up to 5 volts and 1 ampere.

The innovative system is designed to learn the signals of multiple remote control devices, store those signals, and present them to a user in a selectable (and preferably configurable) fashion. Thus, the innovative system is used to “learn” the signals of a remote control associated with an appliance, store that signal, and replay (i.e., transmit) it at the user's request to control the appliance. The user requests that the system transmit a given signal through the user's configurable interface, discussed further below.

In learn mode, the innovative system receives and stores the signals presented to it. FIG. 2 shows a flow chart of the steps for learning a signal in one preferred embodiment. In learn mode, the IR receiver detects the signal of a remote control (step 200), where the remote control is associated with an appliance to be controlled by the innovative system. Such remote controls typically have many different signals they are capable of sending to their respective appliance. The innovative system passes the received signal to the CPLD (step 202), which samples the signal and stores the signal in memory (step 204). The microprocessor of the innovative system retrieves the sampled signal from the memory and passes it to the computer, preferably via the USB (step 206). (In alternative embodiments, only a representation or address of the sampled signal is actually forwarded to the computer, while the signal itself resides in memory.)

At the computer, the sampled signal is associated with a user input action (step 208). For example, depending on the implementation, the computer preferably has a program thereon which allows the user to select an input action, tie that input action to a graphic (like an on-screen button that can be clicked with a mouse or selected with keystrokes) such that when the user performs the input action, the signal associated with that input action is selected for transmission.

The innovative system is capable of learning preferably all the functions of a given remote control device in the above described manner. Additionally, the functions of other remote controls (associated with different appliances of course) can be learned and added to the innovative configurable user interface. Thus, the system can learn the remote control signals for several appliances and present them to a user in a unified format, preferably configurable by the user.

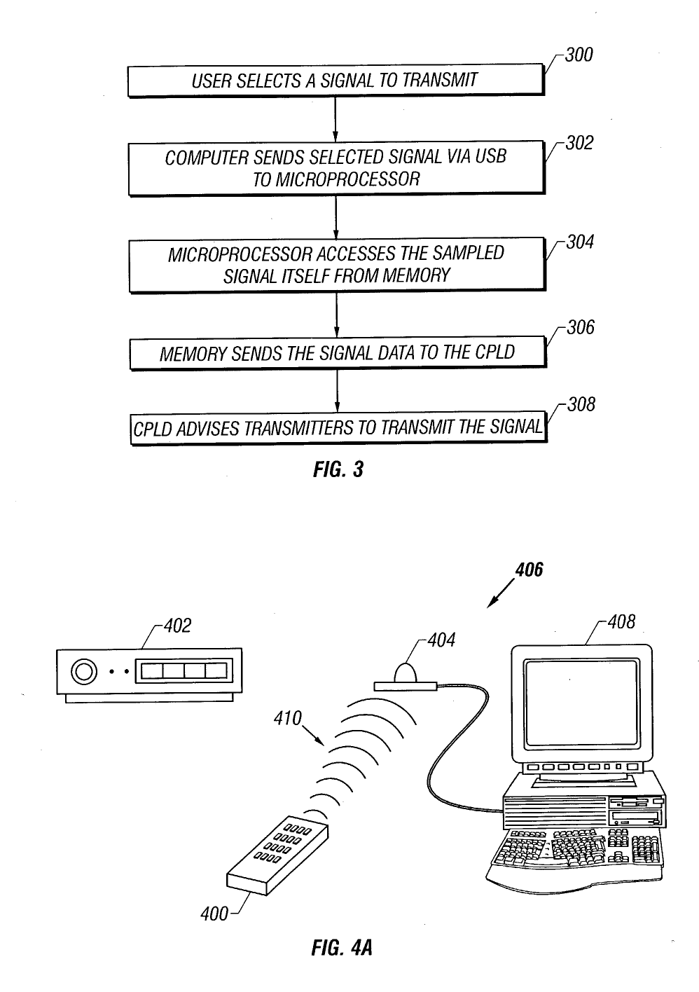

The transmission mode of the innovative system is described by the flow chart of FIG. 3. The user first selects a signal to transmit (step 300) that corresponds to an action of an appliance. For example, if the innovative system has learned the “Play” button of a VCR's remote control, then the user can select the input action associated with causing the VCR to play. The computer sends the sampled signal itself (or data corresponding to the selected signal, depending on the implementation) to the microprocessor via the USB (step 302). The microprocessor accesses the recorded waveforms of the selected sampled signal in the memory (step 304) via the CPLD. The memory sends the data of the selected signal to the CPLD (step 306), which causes the transmitters to emit a copy of the selected signal (step 308). The transmitted signal is received and responded to by the target appliance.

The transceiver device preferably comprises multiple IR LEDs spaced such that they can transmit in multiple directions. This feature allows the transceiver device to be placed centrally in a room and communicate with several appliances for which the innovative system has learned remote control signals.

The innovative system is capable of allowing a user to control multiple remote controls for different appliances through a single interface, preferably on a computer. The interface on the computer through which the user controls the system is a program designed to be configurable by the user. For example, the configurable interface can comprise a program that allows the user to create buttons corresponding to a particular appliance control, like the “Play” button on a VCR appliance, and assign that button to the “play” signal sampled from the appropriate remote control in learn mode. By performing the associated input action (e.g., clicking on the newly created “Play” button with a mouse), the user controls the appliance (the VCR in this example) from the user's computer terminal.

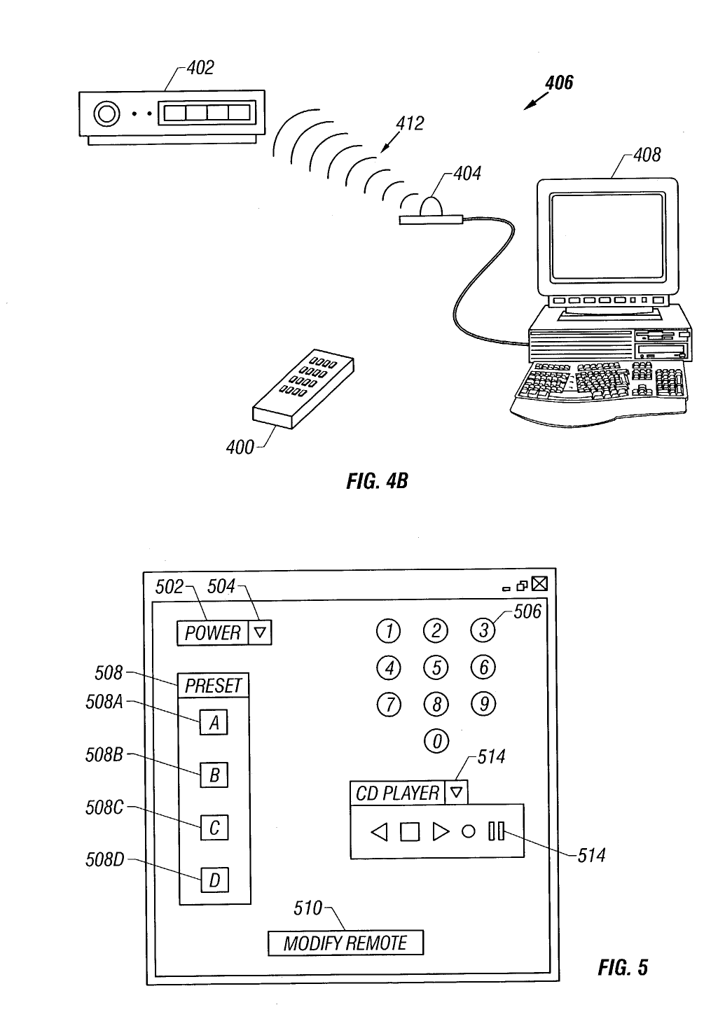

FIG. 4A shows a block diagram of the present innovations in the context of the “learn mode” where the system learns the signals of a particular remote control. In this figure, a remote control 400 associated with an appliance 402 is used to send a given remote control signal 410 to the receiver, which is part of the transceiver 404 of the remote control system 406. The signal is received by the receiver which transmits the signal to memory via the CPLD. The microprocessor causes data associated with the signal to be transmitted to the computer 408. There, the user then uses the interface program on the computer to associate the stored signal with a particular input action. This means, for example, if the “play” command was learned from the remote of the appliance, then a button indicating “play” to the user is associated with that signal. Multiple signals are contemplated to be learned in such a manner, so that the entire functionality of the remote control can be learned by the innovative system.

FIG. 4B shows the present innovations in the “transmit” mode. Once a signal has been learned by the system and associated with a user input action, the system is capable of transmitting that signal to control the appliance 402. In this example, the user (not shown) selects the desired control signal (for example, “play” to cause an appliance to play a given media element) from the computer's user interface. The interface program is preferably configurable so that the user can create buttons (input actions or options) for any number of signals for any number of remote controls and their associated appliances. The computer 408 causes data associated with the appropriate signal to be sent via USB to the transceiver device 404, which then transmits the signal 412 (using the appropriate transmitter or transmitters) to the appliance 402. The signal 412 is a duplicate of the learned signal 410 from FIG. 4A. The signal 412 causes the appliance 402 to perform the transmitted function.

FIG. 5 shows an example configuration for a remote control interface using the innovative system. In this example, the user has positioned the buttons as shown using a program designed for the task, and assigned functions to the buttons corresponding to learned signals from various remotes for various appliances. It is noted that this is only one possible configuration of the remote, which is designed to allow a user to add, remove, move, and reassign buttons as desired.

In the upper left is power button 502. This button can be assigned, for example, to turn on not only a single appliance, but also a host of appliances at the user's choice. For example, a user may have the remote preconfigured to automatically turn on a stereo, a television set, and a DVD (digital versatile disc) player all at once. In this case, invoking the power button 502 would cause the innovative system to send out previously learned signals for powering on these appliances. Next to the power button 502 is a pulldown menu 504. This button is configured to show individual power on commands for individual appliances, in case the user desired only to turn on a television set, for example, without turning on the other appliances set to turn on from power button 502.

Integer buttons 506 present a user with standard numerical input. As with the other input options, these buttons could be removed entirely if not needed. Preset buttons 508 are configurable buttons that can have various tasks assigned to them. For example, preset A 508A could be configured to start the stereo and select disk 5 from a carousel, and play a predetermined sequence of favorite tracks from that disk. Preset B 508B could be programmed to power on a different appliance, such as a VCR. Preset C 508C could be programmed to perform an alternate start up sequence, different than that invoked by the power button 502. For example, Preset C 508C can be programmed to start the television and VCR, but not the stereo, and change the channel on the television to a set channel. Preset D 508D could be programmed for yet another set of actions, such as turning on the VCR and programming the VCR to record a favorite show at a later time, all using the commands originally accessed by the VCR's original remote.

The preset buttons 508 can be configured by the user. This means buttons can be added or removed, and their functions can change. A program is preferably designed to control this configuration process, accessed for example by the Modify Remote button 510 at the bottom of FIG. 5. This program preferably allows a user to control the shape and function and presentation of all remote controls in the innovative system. The program also preferably allows users to preprogram sequences of commands and link the execution of such sequences to preset buttons 508, for example. The names of the buttons are also preferably configurable, so that preset A can instead be called “CD Player Favorites #1” so that a user can easily recall what set of functions are invoked that button.

Standard commands can be added using other buttons 512 that allow a user to manipulate appliances with individual commands, such as play or stop. These buttons can include pulldown menus 514 determining what appliance is commanded by that panel and allowing easy switching between appliances. For example, the panel 512 could be set on the CD player, which would make the play button send out the command for causing the CD player to play. A user can select a different second appliance from the pulldown menu 514 so that the play button will now invoke the play function of that second appliance.

In this way, a remote control is presented that allows a user to use the computing power of a personal computer (for example) to configure select and run remote control commands. This provides the advantage of greater flexibility to remote functions compared to remotes that require all hardware and software to reside in the remote control device itself, such as in standard “master remotes” of prior art. It also allows a user to use the computer's computing power to configure sequences of commands and organize different remote control functions. The innovative system also allows a user to control all remote functions from a central location. It also allows new input options (e.g., buttons) to be added to the interface itself, bypassing the limitations of hardwired master remotes that have only a set number of input options. By adding input options to the user interface, a user can configure the innovative master remote system to control any arrangement of appliances in the fashion that is most efficient for that user for example, a given user may typically begin use of appliances by turning on a television, a VCR, a DVD player, and a stereo (which can play the sounds of the television). With the innovative remote system, the user could set a single input option so that all these appliances are started with the click of that input option.

In alternative embodiments, the interface of the remote control is itself contained in a wireless device, such as a touch screen handheld computer. This device acts as a relay between the computer and the appliances, sending requests for signals to the computer (as invoked by the user) and receiving those signals from the computer, then forwarding them to the appliance. In this way, the programming power necessary to sample and store remote signals still resides on the computer system, while those commands are invoked from the innovative wireless remote.

1. A method for remotely controlling appliances, comprising the steps of:
storing a signal in a computer, the signal being capable of remotely controlling an appliance when transmitted;
causing a transmitter to transmit the signal by selecting a first input option, the first input option being presented to a user on a user interface; and
when a new signal is stored in the computer, adding a second input option to the interface.

2. The method of claim 1, wherein new input options can be added by a user via the interface.

3. The method of claim 1, wherein the transmitter transmits to a plurality of appliances.

4. The method of claim 1, wherein selecting a third input option causes a plurality of signals to be transmitted.

5. A method of controlling appliances, the method comprising the steps of:
detecting a first signal with a receiver, the first signal coming from a remote control associated with a first appliance;
storing the first signal in a memory device;
transmitting data associated with the first signal to a computer, the computer having software that presents a user interface, the user interface having user-configurable input options;
associating a first input option of the interface with the first signal; and
when a user selects the first input option, transmitting a copy of the first signal to the first appliance.

6. The method of claim 5, wherein the input action comprises clicking on a button with a mouse.

7. The method of claim 5, further comprising the steps of:
detecting a second signal with the receiver;
storing the second signal in a memory device;
transmitting data associated with the second signal to the computer;
associating a second input option of the software with the second signal; and
when a user selects the second input option, transmitting a copy of the second signal.

8. The method of claim 7, wherein the second signal is associated with a second appliance.

9. The method of claim 5, wherein the first signal is an infra-red signal.

10. The method of claim 5, wherein the appliance is selected from the group consisting of television, VCR, DVD player, and stereo receiver.

11. A remote control system, comprising:
a computer having interface software;
a transmit/receive device, the transmit/receive device having
a receiver capable of receiving a signal from an external remote control designed to control an external device;
a plurality of transmitters capable of transmitting signals to the external device;
a microprocessor, the microprocessor connected to a logic device, the logic device connected to a memory device and to the receiver and the plurality of transmitters;
wherein the receiver receives a signal from the external remote control and passes the signal to the logic device, which samples the signal and stores the sampled signal in the memory device;
wherein the microprocessor retrieves the sampled signal from the memory via the logic device and sends the sampled signal to the computer;
wherein upon a user selection of an input parameter, the computer sends data associated with the sampled signal to the microprocessor; and
wherein the microprocessor sends the data to the logic device, which uses at least one transmitter of the plurality to transmit the data to an appliance associated with the external remote control.

12. The system of claim 11, wherein the plurality of transmitters and the receiver transmit and receive infra-red signals, respectively.

13. The system of claim 11, wherein the input parameter comprises a button in a user interface capable of being selected by a computer user.

14. The system of claim 13, wherein the input parameter is one of a plurality of input parameters, the plurality of input parameters being configurable by the computer user.

15. The system of claim 11, wherein the appliance is selected from the group consisting of television, VCR, DVD player, and stereo receiver.

16. A remote control system, comprising:
a computer having a software interface, the software interface having a configurable on-screen appearance and a plurality of configurable user input actions;
a transceiver device including a transmitter, a receiver, a complex programmable logic device, a microprocessor, and a memory device, the transceiver device being connected to the computer;
wherein when the receiver receives a signal from an external remote control associated with an external appliance, the signal is stored in the memory device of the transceiver;
wherein the microprocessor sends data associated with the stored signal to the computer; and
wherein the signal is associated with a first input action of the plurality of configurable user input actions such that when the user performs the first input action, the transceiver device transmits the signal.

17. The system of claim 16, wherein the transmitter and receiver transmit and receive infra-red signals, respectively.

18. The system of claim 16, wherein the plurality of user input actions comprises control capability for multiple different remote control devices associated with multiple different appliances.

19. The system of claim 16, wherein the appliance is selected from the group consisting of television, VCR, DVD player, and stereo receiver.

20. A system for remotely controlling appliances, comprising:
a receiver for receiving input signals from remote control devices;
a transmitter for outputting signals to appliances;
a computer system which stores input signals from remote control devices and recalls them for transmission to appliances via the transmitter;
wherein the computer presents a user of the system with a configurable input interface in a window on a monitor.

21. The system of claim 20, wherein the configurable input interface allows the user to select placement and function of input options within the interface.

22. The system of claim 20, wherein the interface is configured so that a single input action simultaneously sends a plurality of commands to a plurality of appliances.

23. The system of claim 22, wherein a first command of the plurality of commands causes a first appliance of the plurality of appliances to power on;
wherein a second command of the plurality of commands causes a second appliance of the plurality of appliances to power on and play a media element.

24. The system of claim 23, wherein the first appliance is a television set;
wherein the second appliance is a digital versatile disc player; and
wherein the media element is a digital versatile disc.

25. The system of claim 20, wherein the interface is configured so that a single input action sends a plurality of commands to a single appliance.

26. The system of claim 25, wherein the plurality of commands to a single appliance causes the appliance to power on, load a media element, and play predetermined tracks of the media element.

27. A system for remotely controlling appliances, comprising:
a transmitter capable of sending a signal to a plurality of appliances;
a computer which stores signals and retrieves a signal for transmission when a request is made by a user;
wherein the request is made by selecting an input option on an interface, the interface presented to the user by the computer;
wherein when a new signal is stored in the computer, a new input option is added to the interface.

28. The system of claim 27, wherein the input option is a button on a computer screen which is selectable by mouse click.

29. The system of claim 27, wherein selecting a second input option causes a new set of input options to be displayed.
